(19) United States
(12) Patent Application Publication
(10) Pub. No.: US 2014/0029923 A1
(43) Pub. Date: Jan. 30, 2014

(54) IMAGE PROCESSING APPARATUS

(71) Applicant: Xacti Corporation, Daito-shi (JP)

(72) Inventor: Hideo HIRONO, Ichinomiya-shi (JP)

(73) Assignee: Xacti Corporation, Daito-shi (JP)

(21) Appl. No.: 13/951,684

(22) Filed: Jul. 26, 2013

(30) Foreign Application Priority Data
Jul. 27, 2012 (JP) JP2012-167664

(51) Int. Cl. H04N 7/01

(52) U.S. Cl. CPC H04N 7/013
USPC 386/343

(57) ABSTRACT

An image processing apparatus includes a first creator. A first creator creates a first moving-image having a first frame rate based on output of an imager during a first period. A second creator creates a second moving-image having a second frame rate higher than the first frame rate based on the output of the imager during a second period belonging to the first period. A reproducer reproduces any one of the first moving-image created by the first creator and the second moving-image created by the second creator. A switcher switches a reproducing target of the reproducer in response to a switching instruction issued during a period corresponding to the second period.

### CROSS REFERENCE OF RELATED APPLICATION

The disclosure of Japanese Patent Application No. 2012-167664, which was filed on Jul. 27, 2012, is incorporated herein by reference.

### BACKGROUND OF THE INVENTION

1. Field of the Invention

The present invention relates to an image processing apparatus, and in particular, relates to an image processing apparatus which reproduces a plurality of moving images representing a common scene in different manners.

2. Description of the Related Art

According to one example of this type of apparatus, when a tele/wide simultaneous shooting mode is set, a zoom lens of a right-imaging system and a zoom lens of a left-imaging system are respectively set on different zoom positions. A wide-side image is photographed with the right-imaging system, and a tele-side image is photographed with the left-imaging system. The tele-side image is displayed on a whole monitor screen, and the wide-side image is reduced and displayed within a frame structure assigned to a part of the monitor screen. A user is able to recognize a photographing range of each of the wide-side image and the tele-side image and confirm details of an object.

However, in the above-described apparatus, recording a moving image is not assumed, and therefore, a visibility of an object appeared in a reproduced image is limited.

### SUMMARY OF THE INVENTION

An image processing apparatus according to the present invention comprises: a first creator which creates a first moving-image having a first frame rate based on output of an imager during a first period; a second creator which creates a second moving-image having a second frame rate higher than the first frame rate based on the output of the imager during a second period belonging to the first period; a reproducer which reproduces any one of the first moving-image created by the first creator and the second moving-image created by the second creator; and a switcher which switches a reproducing target of the reproducer in response to a switching instruction issued during a period corresponding to the second period.

According to the present invention, an image processing program recorded on a non-transitory recording medium in order to control an image processing apparatus, the program causing a processor of the image processing apparatus to perform the steps comprises: a first creating step of creating a first moving-image having a first frame rate based on output of an imager during a first period; a second creating step of creating a second moving-image having a second frame rate higher than the first frame rate based on the output of the imager during a second period belonging to the first period; a reproducing step of reproducing any one of the first moving-image created by the first creating step and the second moving-image created by the second creating step; and a switching step of switching a reproducing target of the reproducing step in response to a switching instruction issued during a period corresponding to the second period.

According to the present invention, an image processing method executed by an image processing apparatus, comprises: a first creating step of creating a first moving-image having a first frame rate based on output of an imager during a first period; a second creating step of creating a second moving-image having a second frame rate higher than the first frame rate based on the output of the imager during a second period belonging to the first period; a reproducing step of reproducing any one of the first moving-image created by the first creating step and the second moving-image created by the second creating step; and a switching step of switching a reproducing target of the reproducing step in response to a switching instruction issued during a period corresponding to the second period.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a mapping state of an SDRAM applied to the embodiment in FIG. 2;

FIG. 4 is an illustrative view showing one example of a sub-image information table applied to the embodiment in FIG. 2;

FIG. 5 is an illustrative view showing one example of a relationship between main image data and sub image data;

FIG. 6(A) is an illustrative view showing one example of a structure of a main file created under a camera mode;

FIG. 6(B) is an illustrative view showing one example of a structure of a sub file created under the camera mode;

FIG. 7 is a flowchart showing one portion of behavior of a CPU applied to the embodiment in FIG. 2;

FIG. 8 is a flowchart showing another portion of behavior of the CPU applied to the embodiment in FIG. 2;

FIG. 9 is a flowchart showing still another portion of behavior of the CPU applied to the embodiment in FIG. 2;

FIG. 10 is a flowchart showing yet another portion of behavior of the CPU applied to the embodiment in FIG. 2;

FIG. 11 is a flowchart showing another portion of behavior of the CPU applied to the embodiment in FIG. 2;

FIG. 12 is a flowchart showing still another portion of behavior of the CPU applied to the embodiment in FIG. 2;

FIG. 13 is a flowchart showing yet another portion of behavior of the CPU applied to the embodiment in FIG. 2;

FIG. 14 is a flowchart showing another portion of behavior of the CPU applied to the embodiment in FIG. 2; and

FIG. 15 is a block diagram showing a configuration of another embodiment of the present invention.

### DETAILED DESCRIPTION OF THE PREFERRED EMBODIMENTS

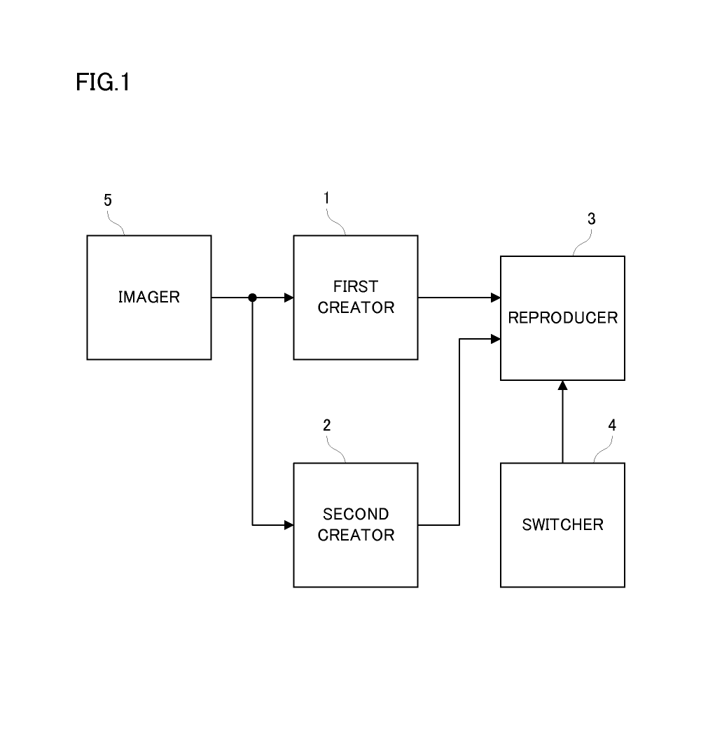

With reference to FIG. 1, an image processing apparatus according to one embodiment of the present invention is basically configured as follows: A first creator 1 creates a first moving-image having a first frame rate based on output of an imager 5 during a first period. A second creator 2 creates a second moving-image having a second frame rate higher than the first frame rate based on the output of the imager 5 during a second period belonging to the first period. A reproducer 3 reproduces any one of the first moving-image created by the first creator 1 and the second moving-image created by the second creator 2. A switcher 4 switches a reproducing target of the reproducer 3 in response to a switching instruction issued during a period corresponding to the second period.

The first moving-image and the second moving-image are based on the output of the common imager 5, and the second frame rate is higher than the first frame rate. Thus, a common object appears in the first moving-image and the second moving-image, and a motion of the object becomes slower when the second moving-image is reproduced.

Moreover, the first moving-image is created during the first period whereas the second moving-image is created during the second period belonging to the first period, and the switching instruction is issued during the period corresponding to the second period. Thus, a moving image to be reproduced is switched between the first moving-image and the second moving-image during the period corresponding to the second period.

As a result, the motion of the object appeared during the second period becomes slower by switching the reproducing target from the first moving-image to the second moving-image, and becomes faster by switching the reproducing target from the second moving-image to the first moving-image. Thus, a visibility of an object appeared during a specific period is improved.

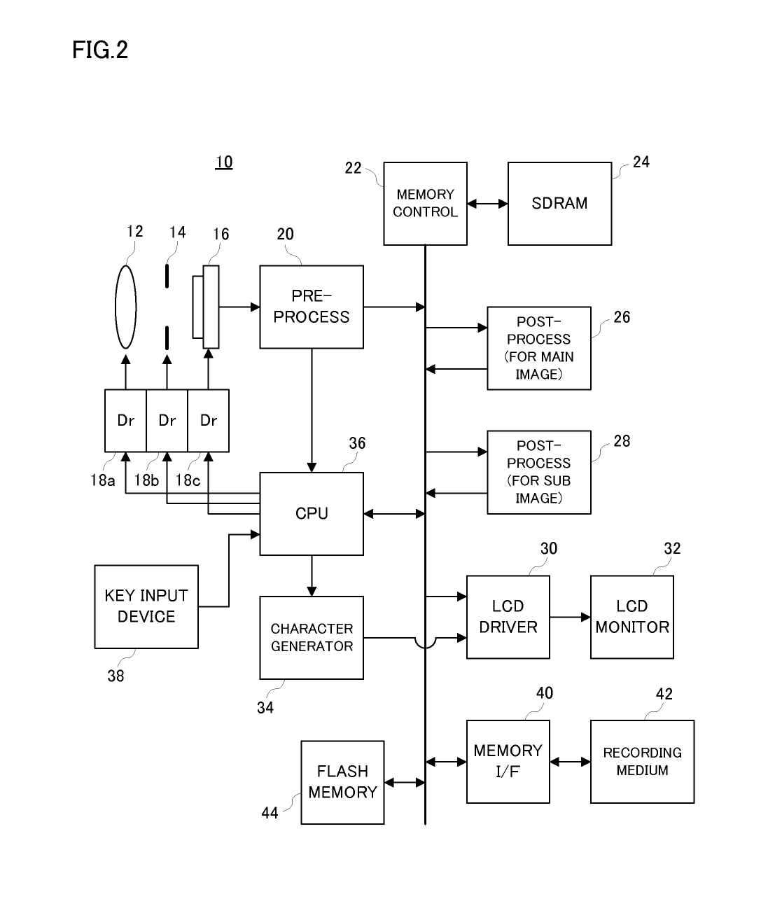

With reference to FIG. 2, a digital video camera 10 according to the embodiment includes a focus lens 12 and an aperture unit 14 driven by drivers 18a and 18b, respectively. An optical image representing a scene enters, with irradiation, an imaging surface of an image sensor 16 through these components.

When a mode selecting operation of selecting a camera mode is performed toward a key input device 38 which accepts a user operation, a CPU 36 activates a driver 18c in order to execute a moving-image taking process under a main-image recording task. In response to a vertical synchronization signal Vsync generated at every 1/30th of a second, the driver 18c exposes the imaging surface and reads out the electric charges produced on the imaging surface in a raster scanning manner. An exposure procedure and an electric-charge reading-out procedure are executed at a rate of once per 1/30th of a second (a rate of once each time the vertical synchronization signal Vsync is generated once), and raw image data generated by the exposure procedure is outputted from the image sensor 16 at a frame rate of 30 fps.

It is noted that, in a period during which a sub-image recording process is performed under a sub-image recording task described later, the driver 18c executes the exposure procedure and an electric-charge reading-out procedure at a ratio of ten times per 1/30th of a second (a ratio of ten times each time the vertical synchronization signal Vsync is generated once). Raw image data is outputted from the image sensor 16 at a frame rate of 300 fps.

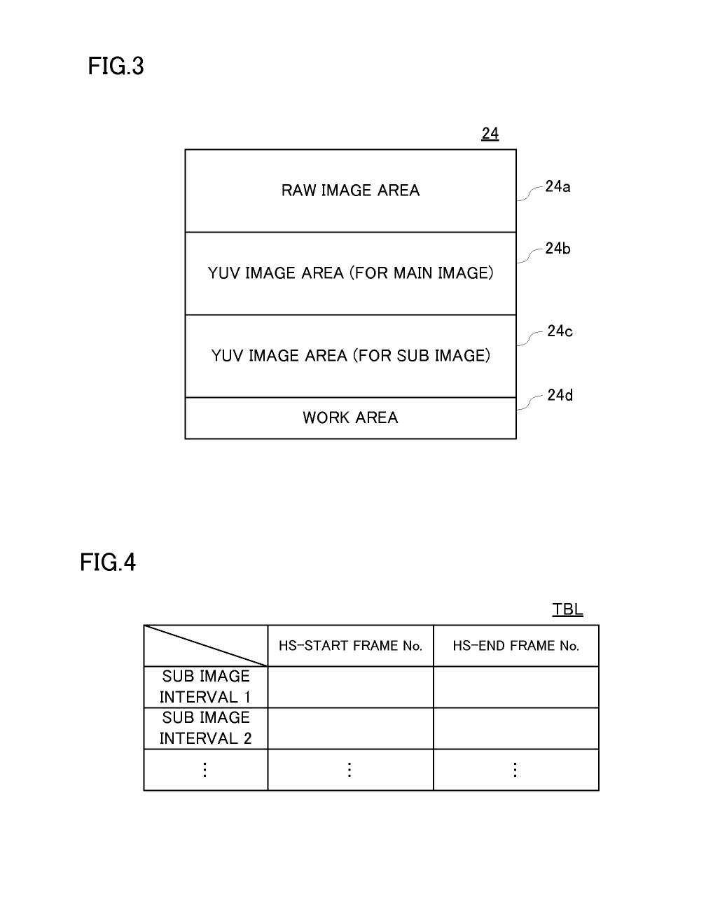

A pre-processing circuit 20 performs processes, such as digital clamp, pixel defect correction, gain control and etc., on the raw image data outputted from the image sensor 16. The raw image data on which these processes are performed is written into a raw image area 24a (see FIG. 3) of an SDRAM 24 through a memory control circuit 22.

A post-processing circuit 26 reads out the raw image data stored in the raw image area 24a through the memory control circuit 22, and performs a series of processes such as color separation, white balance adjustment, YUV conversion, on the read-out raw image data. YUV formatted-image data created thereby, i.e., main image data is written into a YUV image area 24b (see FIG. 3) of the SDRAM 24 through the memory control circuit 22.

It is noted that, irrespective of the sub-image recording process, the post-processing circuit 26 reads out the raw image data from the raw image area 24a at a rate of one frame per 1/30th of a second so as to create the main image data at the rate of one frame per 1/30th of a second. The created main image data is written into the YUV image area 24b at the rate of one frame per 1/30th of a second.

An LCD driver 30 reads out the raw image data stored in the YUV image area 24b, and drives an LCD monitor 32 based on the read-out main image data. As a result, a real-time moving image (a live view image) representing the scene captured on the imaging surface is displayed on a monitor screen. It is noted that, irrespective of the sub-image recording process, the LCD monitor 30 also reads out the main image data from the YUV image area 24b at the rate of one frame per 1/30th of a second.

Moreover, the pre-processing circuit 20 simply converts the raw image data into Y data, and applies the converted Y data to the CPU 36. The CPU 36 executes an AE process on the Y data under the parameter adjusting task, and calculates an appropriate EV value. An aperture amount and an exposure time period that define the calculated appropriate EV value are respectively set to the drivers 18b and 18c, and thereby, a brightness of the live view image is adjusted moderately. Moreover, when an AF start-up condition is satisfied, the CPU 36 performs an AF process on a high-frequency component of the Y data. The focus lens 12 is placed at a focal point by the driver 18a, and thereby, a sharpness of the live view image is continuously improved.

When a main-recording start operation is performed toward the key input device 38, the CPU 36 accesses a recording medium 42 through an I/F 40 under the main-image recording task so as to newly create a main file and a sub file onto the recording medium 42 (the created main file and sub file are opened).

File name MOV****.MAIN (“****” is an identification number, hereinafter) is assigned to the main file, and file name MOV****.SUB is assigned to the sub file. Here, a common identification number is assigned to both of a main file and a sub file to be concurrently created, and the main file and sub file concurrently created are associated with each other by the identification number.

When the main file and sub file are created, the CPU 36 commands the memory I/F 40 to start the main-image recording process. Moreover, the CPU 36 increments a main frame number from “1”, at every time the vertical synchronization signal Vsync is generated (=at every 1/30th of a second). Main image data of each frame to be recorded is identified by the main frame number thus incremented. The memory I/F 40 reads out the main image data stored in the YUV image area 24b through the memory control circuit 22 at every time the vertical synchronization signal Vsync is generated, and writes the read-out main image data into the main file created in the recording medium 42 in a manner described above.

When a sub-recording start operation is performed toward the key input device 38, under the under a sub-image recording task, the CPU 36 changes the frame rate of the image sensor 16 from 30 fps to 300 fps. Raw image data is outputted from the image sensor 16 at a rate of one frame per 1/300th of a second.

Subsequently, the CPU 36 activates a post-processing circuit 28, and commands the memory I/F 40 to start the sub-image recording process. The post-processing circuit 28 reads out the raw image data stored in the raw image area 24a at the rate of one frame per 1/300th of a second, and performs a series of processes such as color separation, white balance adjustment, YUV conversion, on the read-out raw image data. As a result, YUV formatted sub-image data is created at the rate of one frame per 1/300th of a second. The created sub-image data is written into a YUV image area 24c at the rate of one frame per 1/300th of a second. The memory I/F 40 reads out the sub-image data stored in the YUV image area 24c at the rate of one frame per 1/300th of a second, and writes the read-out sub-image data into the sub file created in the recording medium 42, at the same rate.

When a sub-recording end operation is performed toward the key input device 38, the CPU 36 stops the post-processing circuit 28, commands the memory I/F 40 to end the sub-image recording process, and returns the frame rate of the image sensor 16 from 300 fps to 30 fps. The post-processing circuit 28 stops reading out the raw image data from the raw image area 24a, and the memory I/F 40 ends writing the sub-image data into the sub file.

A sub-image information table TBL shown in FIG. 4 is prepared in a work area 24d of the SDRAM 24. When the sub-recording start operation is performed, the CPU 36 accesses the work area 24d through the memory control circuit 22, and describes a current main-frame number in the sub-image information table TBL as an HS-start frame number. Moreover, when the sub-recording end operation is performed, the CPU 36 describes a current main-frame number in the sub-image information table TBL as an HS-end frame number.

In this embodiment, the sub-recording end operation is accepted only during execution of the sub-image recording process, and the HS-start frame number and the HS-end frame number are described in the sub-image information table TBL, pairing with each other. A sub-image interval is defined by a pair of the HS-start frame number and HS-end frame number. Thus, when the sub-recording start operation and the sub-recording end operation are respectively performed twice in the middle of the main-image recording process, sub-image intervals 1 and 2 are defined as shown in FIG. 5.

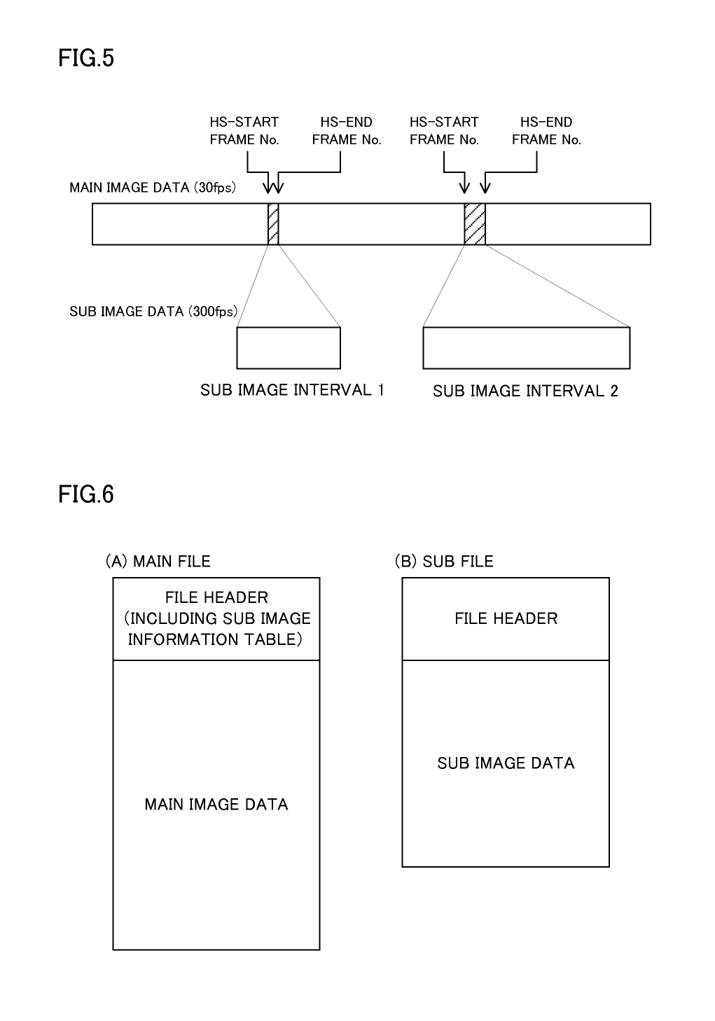

When the sub-recording end operation is performed toward the key input device 38, under the main-image recording task the CPU 36 commands the memory I/F 40 to end the main-image recording process. As a result, reading out the main image data from the YUV image area 24b is ended. Thereafter, the CPU 36 closes the sub file in an opened state, writes the sub-image information table TBL on the work area 24d into a header of the main file, and closes the main file. As a result, the main file and the sub file associated with each other are completed as shown in FIG. 6(A) and FIG. 6(B).

It is noted that, when the image data does not exist in the sub file, writing the sub-image information table TBL is omitted, and the sub file is deleted.

When a reproducing mode is selected by the mode selecting operation toward the key input device 38, the CPU 36 executes following processes under an image reproducing task. Firstly, any one of a plurality of main files recorded in the recording medium 42 is designated according to a file designating operation toward the key input device 38.

When a sub file corresponding to the designated main file exists in the recording medium 42, the CPU 36 acquires through the memory I/F 40 the sub-image information table TBL described in a header of the main file. The acquired sub image information table TBL is written into the work area 24d of the SDRAM 24 through the memory control circuit 22.

When a main-reproducing start operation is performed toward the key input device 38, the CPU 36 commands the memory I/F 40 and the LCD driver 30 to start a main-image reproducing process, and increments the main frame number from “1” at every time the vertical synchronization signal Vsync is generated.

The memory I/F 40 reads out one frame of main image data corresponding to a current main frame number from the main file designated in a manner described above, and writes the read-out main image data into the YUV image area 24b of the SDRAM 24, through the memory control circuit 22. The LCD driver 30 reads out the main image data stored in the YUV image area 24b through the memory control circuit 22, and drives the LCD monitor 32 based on the read-out main image data. As a result, a moving image based on a successive plurality of main image data, i.e., a main moving image is displayed on the monitor screen.

When a current main frame number is in a sub-image interval defined by a description of the sub-image information table TBL, the CPU 36 applies a marker display command to a character generator 34. The character generator 34 creates character data indicating a marker notifying a presence of a sub image, and applies the created character data to the LCD driver 30. The LCD driver 30 multiple-displays the marker on the monitor screen, based on the applied character data.

It is noted that, when the current main-frame number deviates from the sub-image interval, the CPU 36 applies a marker hiding command to the character generator 34. As a result, the marker disappears from the monitor screen.

When a sub-reproduction start operation is performed toward the key input device 38 in a period during which the marker is displayed, the CPU 36 commands the memory I/F 40 and the LCD driver 30 to end the main-file reproducing process, and detects a sub frame corresponding to a current main-frame number based on an HS-start frame number defining a current sub-image interval and a frame rate (=300 fps) of sub image data.

Subsequently, the CPU 36 commands the memory I/F 40 and the LCD driver 30 to start a sub-image reproducing process. Moreover, the CPU 36 increments the main frame number every time the vertical synchronization signal Vsync is generated ten times.

The memory I/F 40 reads out sub image data beginning with the sub frame detected in a manner described above, and writes the read-out sub image data into the YUV image area 24c of the SDRAM 24 through the memory control circuit 22. The LCD driver 30 reads out the sub image data stored in the YUV image area 24c, and drives the LCD monitor 32 based on the read-out sub image data.

Here, transferring the sub image data from the sub file to the YUV image area 24c and from the YUV image area 24c to the LCD driver 30 is executed in response to the vertical synchronization signal Vsync (at a rate of one frame per 1/30th of a second). As a result, a speed of a motion of a moving image that is based on the sub image data, i.e., a sub moving image is decreased to 1/10th of a time of recording.

When a sub-reproduction end operation is operated or a current main frame number reaches an HS-end frame number defining a sub-image interval at a current time point, the CPU 36 commands the memory I/F 40 and the LCD driver 30 to end the sub-image reproducing process. As a result, reproducing the sub moving image is ended.

Thereafter, the CPU 36 commands the memory I/F 40 and the LCD driver 30 to start the main-image reproducing process, and increments the main frame number at every time the vertical synchronization signal Vsync is generated. The main-image reproducing process is executed on main image data of a frame equivalent to the main frame number thus incremented. As a result, the main moving image is displayed on the LCD monitor 32.

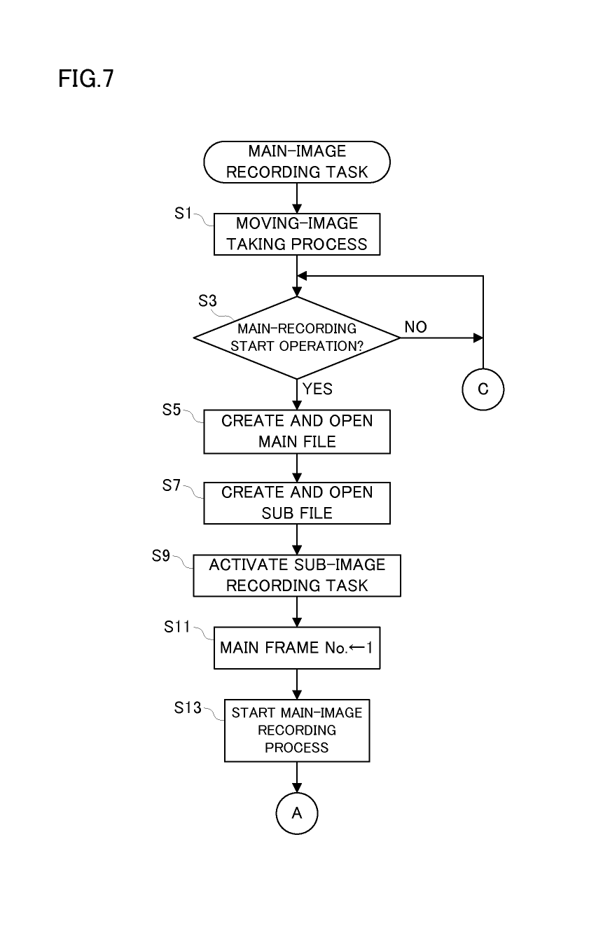

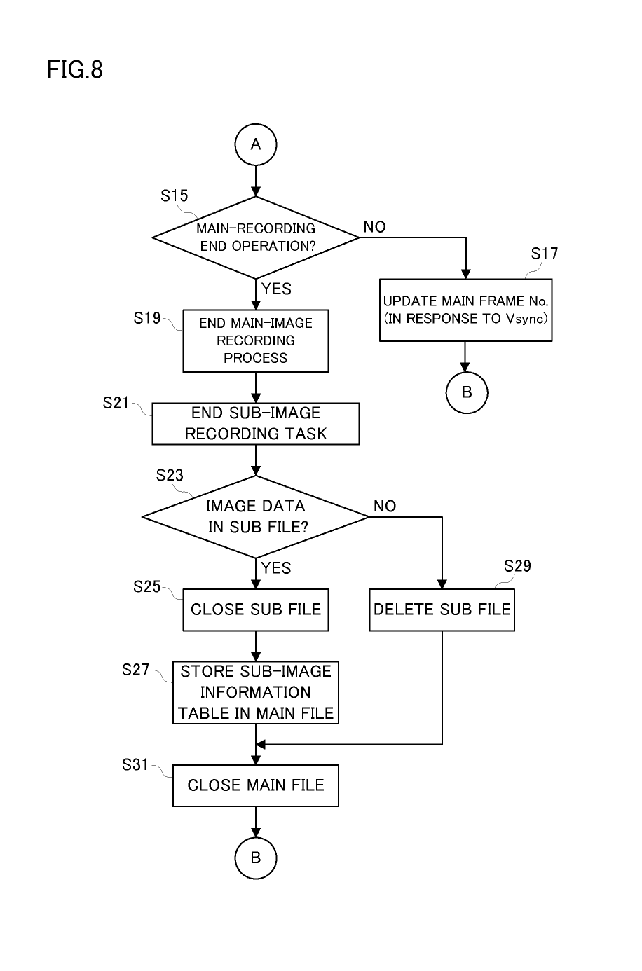

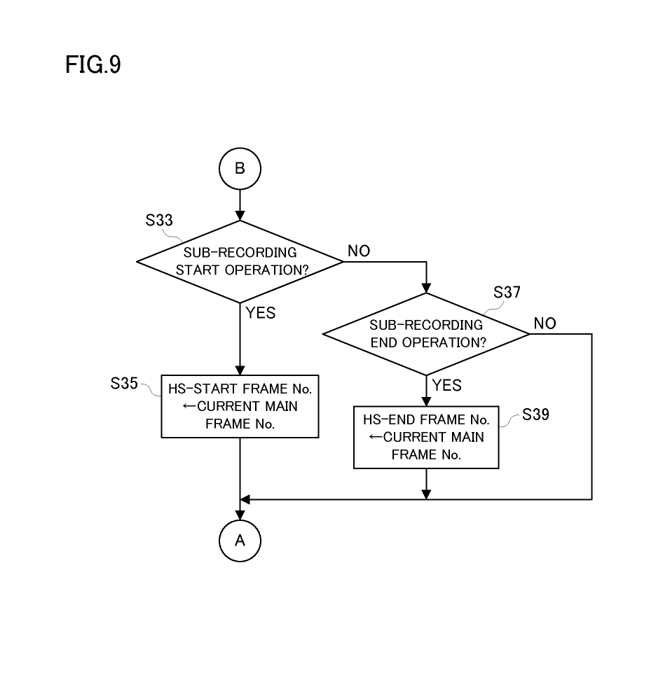

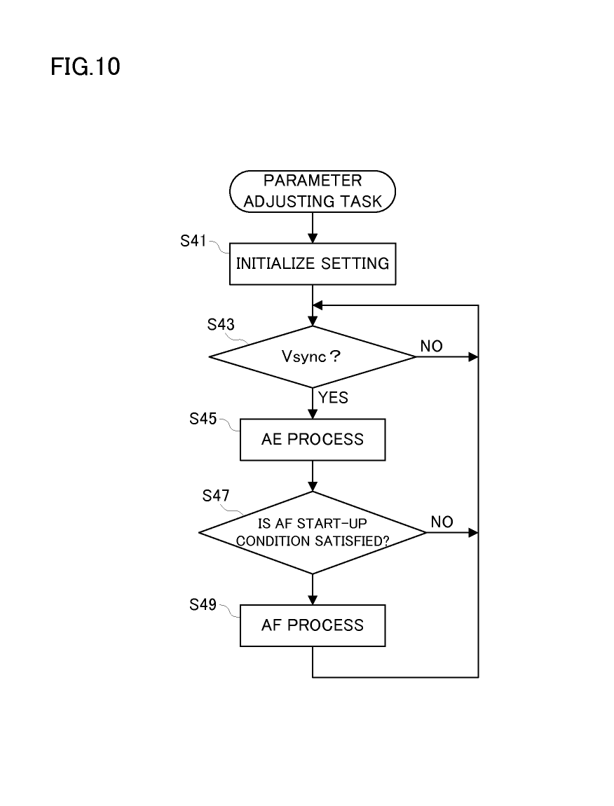

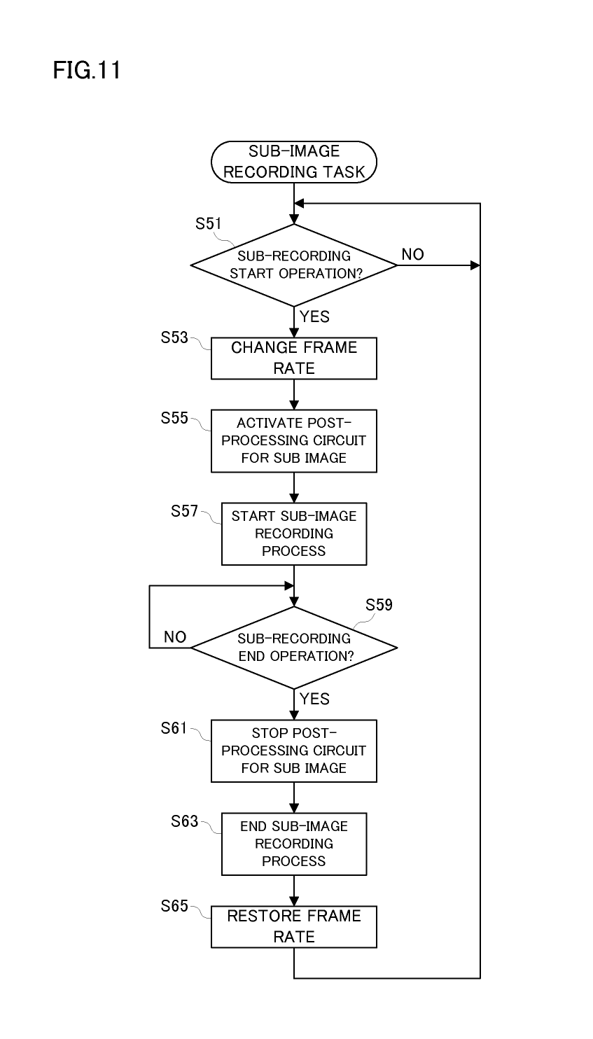

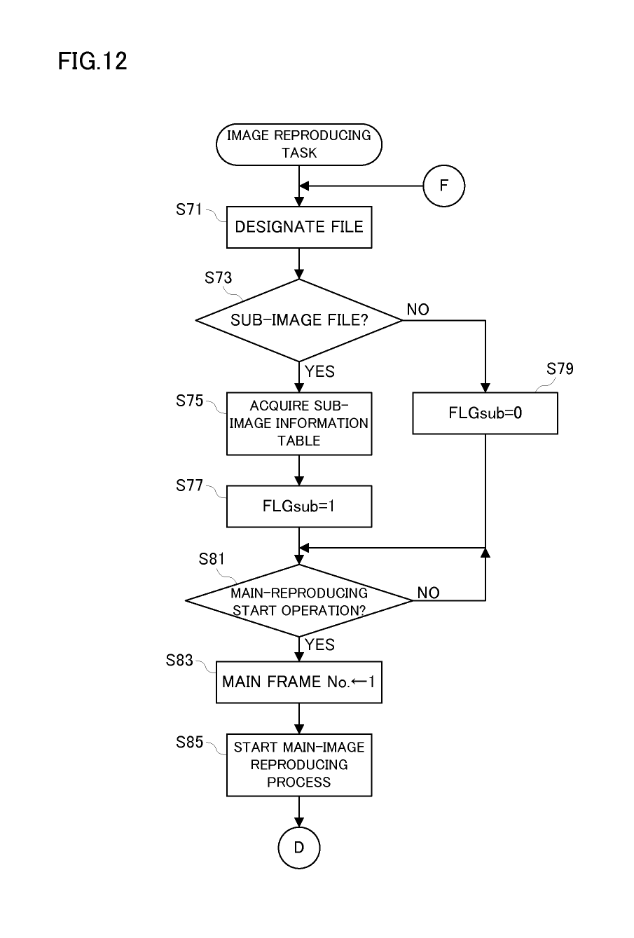

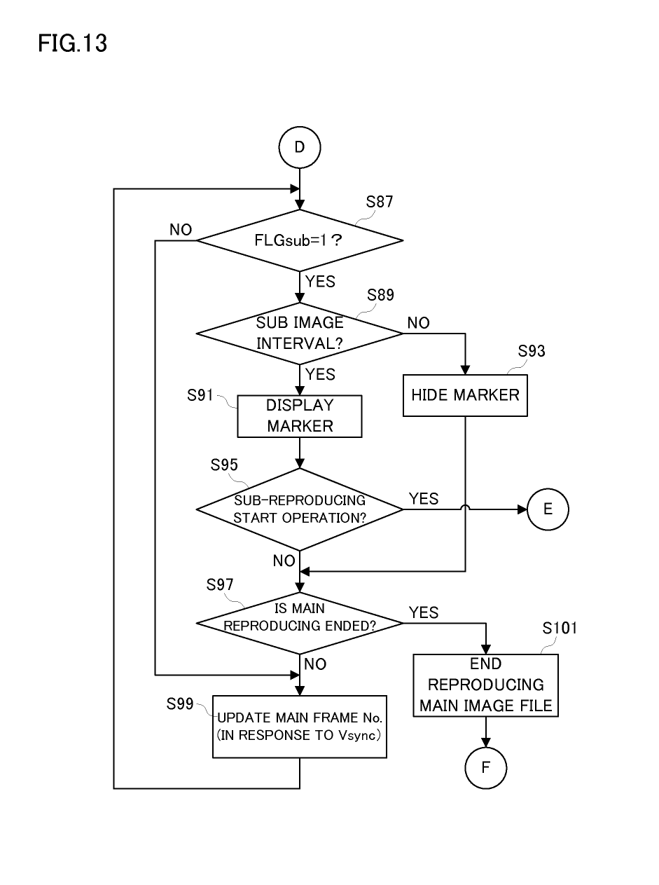

The CPU 36 executes, under the multi task operating system, a plurality of tasks including the main image recording task shown in FIG. 7 to FIG. 9, the parameter adjusting task shown in FIG. 10, the sub control task shown in FIG. 11 and the image reproducing task shown in FIG. 12 to FIG. 14, in a parallel manner. It is noted that, control programs corresponding to these tasks are stored in a flash memory 44.

With reference to FIG. 7, in a step S1, the moving-image taking process is executed. Thereby, a live view image is displayed on the LCD monitor 32. In a step S3, it is determined whether or not the main recording start operation is performed, and when a determined result is updated from NO to YES, the process advances to processes in steps S5 to S7. In the steps S5 to S7, the recording medium 42 is accessed through the memory I/F 40, and newly creates a main file and a sub file in an opened state in the recording medium 42.

In a step S9, the sub-image recording task is activated, in a step S11, the main frame number is set to “1”, and in a step S13, the memory I/F 40 is commanded to start the main-image recording process. The memory I/F 40 reads out main image data stored in the YUV image area 24b through the memory control circuit 22, and writes the read-out main image data into the main file created in the step S5.

In a step S15, it is determined whether or not the main recording end operation is performed. When a determined result is No, the process advances to a step S17 so as to increment the main frame number after generation of the vertical synchronization signal Vsync. Upon completion of incrementing, in a step S33, it is determined whether or not the sub-recording start operation is performed, and in a step S37, it is determined whether or not the sub-recording end operation is performed.

When a determined result of the step S33 is YES, the process advances to a step S35 so as to set a current main frame number as the HS-start frame number. Moreover, when a determined result of the step S37 is YES, the process advances to a step S39, and a current main frame number is set as the HS-end frame number. The HS-start frame number and the HS-end frame number are written into the sub-image information table TBL on the work area 24c through the memory control circuit 22. Upon completion of the process in the step S35 or S37, the process returns to the step S15. It is noted that, when both of the determined result of the step S33 and the determined result of the step S37 are NO, the process directly returns to the step S15.

In this embodiment, the sub-recording end operation is accepted only during execution of the sub-image recording process, and the HS-start frame number and the HS-end frame number are described in the sub-image information table TBL, pairing with each other. The sub-image interval is defined by a pair of the HS-start frame number and HS-end frame number.

When the determined result of the step S15 is updated to YES, the process advances to a step S19, and the memory I/F 40 is commanded to end the main-image recording process. The memory I/F 40 ends reading out the main image data from the YUV image area 24b.

In a step S21, the sub-image recording task is ended, and in a step S23, it is determined whether or not sub image data is contained in the sub file created in the step S7. When a determined result is YES, the process advances to a step S25, and the sub file in an opened state is closed. In a step S27, the sub-image information table TBL on the work area 24c is read out through the memory control circuit 22, and the read-out sub-image information table TBL is written into a header of the main file created in the step S5. When the determined result of the step S23 is NO, the process advances to a step S29, and the sub file in the opened state is deleted.

In a step S31, the recording medium 42 is accessed through the memory I/F 40 so as to close the main file in the opened state. Upon completion of closing the main file, the process returns to the step S3.

With reference to FIG. 10, in a step S41, a focus, an aperture amount and an exposure time period are initialized. In a step S43, it is determined whether or not the vertical synchronization signal Vsync is generated, and when a determined result is updated from NO to YES, the AE process is executed in a step S45. Thereby, a brightness of the live view image is adjusted moderately. In a step S47, it is determined whether or not an AF start-up condition is satisfied. When No is determined, the process directly returns to the step S43 whereas when YES is determined, the process returns to the step S43 after the AF process is executed in a step S49. As a result of the AF process, the focus lens 12 is placed at a focal point, and thereby, a sharpness of the live view image is improved.

With reference to FIG. 11, in a step S51, it is determined whether or not the sub-recording start operation is performed. When a determined result is updated from NO to YES, in a step S53, the frame rate of the image sensor 16 is changed from 30 fps to 300 fps. Raw image data is outputted from the image sensor 16 at a rate of one frame per 1/300th of a second.

It is noted that, irrespective of the sub-recording start operation, the post-processing circuit 26 reads out the raw image data from the raw image area 24a at a rate of one frame per 1/30th of a second so as to create the main image data at the rate of one frame per 1/30th of a second. The created main image data is written into the YUV image area 24b at the rate of one frame per 1/30th of a second.

Upon completion of the process in the step S53, the post-processing circuit 28 is activated in a step S55, and in a step S57, the memory I/F 40 is commanded to start the sub-image recording process. The post-processing circuit 28 reads out the raw image data stored in the raw image area 24a at a rate of one frame per 1/300th of a second, and converts the read-out raw image data into sub image data the rate of one frame per 1/300th of a second. The converted sub image data is written into the YUV image area 24c at the rate of one frame per 1/300th of a second. The memory I/F 40 reads out the sub-image data stored in the YUV image area 24c at the rate of one frame per 1/300th of a second, and writes the read-out sub-image data into the sub file created in the step S7.

In a step S59, it is determined whether or not the sub-recording end operation is performed. When a determined result is updated from NO to YES, in a step S61, the post-processing circuit 28 is stopped, and in a step S63, the memory I/F 40 is commanded to end the sub-image recording process. The post-processing circuit 28 stops reading out the raw image data from the raw image area 24a, and the memory I/F 40 ends writing the sub-image data into the sub file. Upon completion of the process in the step S63, in a step S65, the frame rate of the image sensor 16 is returned from 300 fps to 30 fps, and thereafter, the process returns to the step S51.

With reference to FIG. 12, in a step S71, any one of a plurality of main files recorded in the recording medium 42 is designated in response to the file designating operation. In a step S73, it is determined whether or not a sub file corresponding to the designated main file exists in the recording medium 42. When a determined result is NO, in a step S79, a flag FLGsub is set to “0”, and thereafter, the process advances to a step S81. In contrary, when a determined result is YES, the process advances to a step S75, and the sub-image information table TBL described in a header of the main file is acquired through the memory I/F 40. The acquired sub image information table TBL is written into the work area 24d of the SDRAM 24 through the memory control circuit 22. In a step S77, the flag FLGsub is set to “1”, and upon completion of setting, the process advances to the step S81.

In the step S81, it is determined whether or not the main-reproducing start operation is performed, and when a determined result is updated from NO to YES, in a step S83, the main frame number is set to “1”. In a step S85, the memory I/F 40 and the LCD driver 30 are commanded to start a main-image reproducing process.

The memory I/F 40 reads out one frame of main image data corresponding to a current main frame number from the main file designated in the step S71, and writes the read-out main image data into the YUV image area 24b of the SDRAM 24, through the memory control circuit 22. The LCD driver 30 reads out the main image data stored in the YUV image area 24b through the memory control circuit 22, and drives the LCD monitor 32 based on the read-out main image data. As a result, a main image of a current frame is displayed on the monitor screen.

In a step S87, it is determined whether or not the flag FLG indicates “1”, and in a step S89, it is determined whether or not a current main frame number belongs to the sub-image interval defined by a description of the sub-image information table TBL. When a determined result of the step S87 is NO, the process directly advances to a step S99, and when a determined result of the step S89 is NO, the process advances to a step S97 after the character generator 34 is applied the marker hiding command in a step S93.

When both of the determined result of the step S87 and the determined result of the step S89 are YES, in a step S91, the character generator 34 is applied the marker display command. In a step S95, it is determined whether or not the sub-reproduction start operation is performed, and in the step S97, it is determined whether or not an OR condition under which a main-reproducing end operation is performed or a current main frame number reaches a tail-end frame of the main file is satisfied.

When both of a determined result of the step S95 and a determined result of the step S97 are NO, the main frame number is incremented after generation of the vertical synchronization signal Vsync. Upon completion of incrementing, the process returns to the step S87. In contrary, when the determined result of the step S95 is NO and the determined result of the step S97 is YES, in a step S101, the memory I/F 40 and the LCD driver 30 are commanded to end the main-file reproducing process. As a result, reproducing a moving image based on the main image data, i.e., a main moving image is ended. Upon completion of the process in the step S101, the process returns to the step S71.

When the determined result of the step S95 is YES, in a step S103, the memory I/F 40 and the LCD driver 30 are commanded to end the main-file reproducing process. In a step S105, a sub frame corresponding to a current main-frame number is detected based on the HS-start frame number defining the current sub-image interval and the frame rate (=300 fps) of the sub image data.

In a step S107, the memory I/F 40 and the LCD driver 30 are commanded to start the sub-image reproducing process. The memory I/F 40 reads out sub image data equivalent to the sub frame number calculated in the step S105 from the sub file, and writes the read-out sub image data into the YUV image area 24c of the SDRAM 24 through the memory control circuit 22. The LCD driver 30 reads out the sub image data stored in the YUV image area 24c, and drives the LCD monitor 32 based on the read-out sub image data.

Here, transferring the sub image data from the sub file to the YUV image area 24c and from the YUV image area 24c to the LCD driver 30 is executed in response to the vertical synchronization signal Vsync (at a rate of one frame per 1/30th of a second). As a result, a speed of a motion of a moving image that is based on the sub image data, i.e., a sub moving image is decreased to 1/10th of a time of recording.

In a step S109, it is determined whether or not an OR condition under which the sub-reproduction end operation is operated or a current main frame number reaches an HS-end frame number defining a sub-image interval at a current time point is satisfied. When a determined result is NO, the process advances to a step S111, and the main frame number is incremented after the vertical synchronization signal Vsync is generated ten times. Upon completion of incrementing, the process returns to the step S109.

When the determined result of the step S109 is updated from NO to YES, in a step S113, the memory I/F 40 and the LCD driver 30 are commanded to end the sub-image reproducing process. As a result, reproducing the sub moving image is ended. In a step S115, the memory I/F 40 and the LCD driver 30 are commanded to start the main-image reproducing process. The main-image reproducing process is executed on main image data of a frame equivalent to the main frame number. Upon completion of the process in the step S115, the process returns to the step S87.

As can be seen from the above-described explanation, the main image data having the frame rate of 30 fps is recorded in the main file by the main-image recording process executed during a period from the main-recording start operation to the main-recording end operation (S3 to S5, S11 to S19, S31). Moreover, the sub image data having the frame rate of 300 fps is recorded in the sub file by the sub-image recording process executed during a period from the sub-recording start operation to the sub-recording end operation (S7 to S9, S21 to S27, S33 to S39, S51 to S65). Here, the sub-recording start operation and the sub-recording end operation are accepted during a period from the main-recording start operation to the main-recording end operation.

The main image data and sub image data thus contained in the main file and sub file are selectively reproduced (S81 to S85, S97 to S101, S105 to S107, S111, S115). Moreover, image data to be a reproducing target is switched in response to each of the sub-reproduction start operation and the sub-reproduction end operation performed in the sub-image interval (S95, S103, S109, S113).

The main image data and the sub image data are based on the output of the common imager sensor 16, and the frame rate of the sub image data is higher than the frame rate of the main image data. Thus, the common object appears in the main image data and sub image data, and the motion of the object becomes slower when the sub image data is reproduced.

Moreover, the main image data is recorded by the main-image recording process whereas the sub image data is recorded by the sub-image recording process temporarily executed in parallel with the main-image recording process, and the sub-reproduction start operation and the sub-reproduction end operation are accepted in the sub-image interval. Thus, the image data to be reproduced is switched between the main image data and the sub image data, in the sub image interval.

As a result, the motion of the object appeared in a period during which the sub-image recording process is executed becomes slower by switching the reproducing target from the main image data to the sub image data, and becomes faster by switching the reproducing target from the sub image data to the main image data. Thus, the visibility of the object appeared in the period during which the sub-image recording process is executed is improved.

It is noted that, in this embodiment, the main image data and the sub image data are created based on the output of the common image sensor 16, however, two image sensors capturing a common scene may be prepared so as to create the main image data based on output of one image sensor, and create the sub image data based on output of another image sensor concurrently. At this time, in a preferable embodiment, the two image sensors are arranged on positions mutually close, in a posture orienting a common direction. Moreover, in another preferable embodiment, an optical image being incident through a common lens is distributed to the two image sensors by a spectroscope.

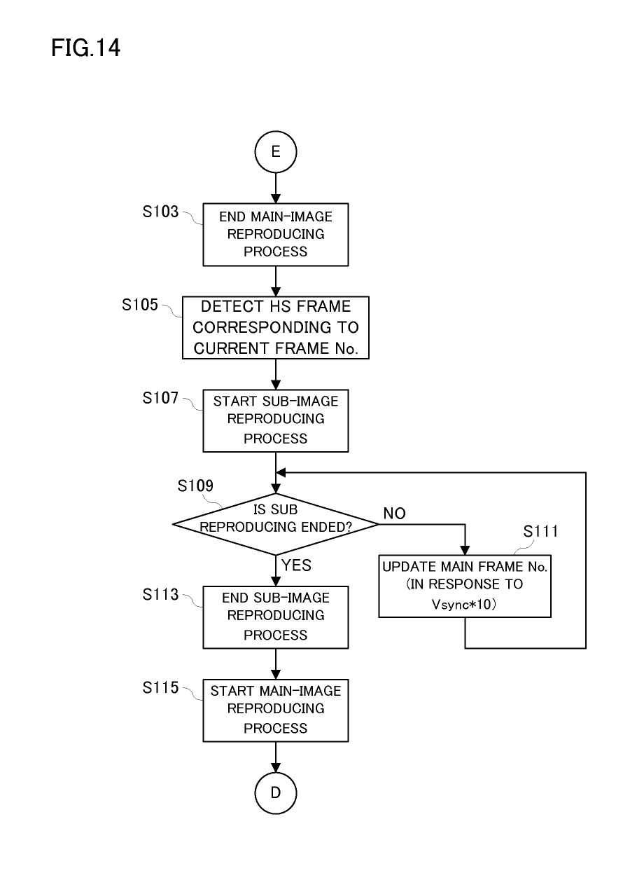

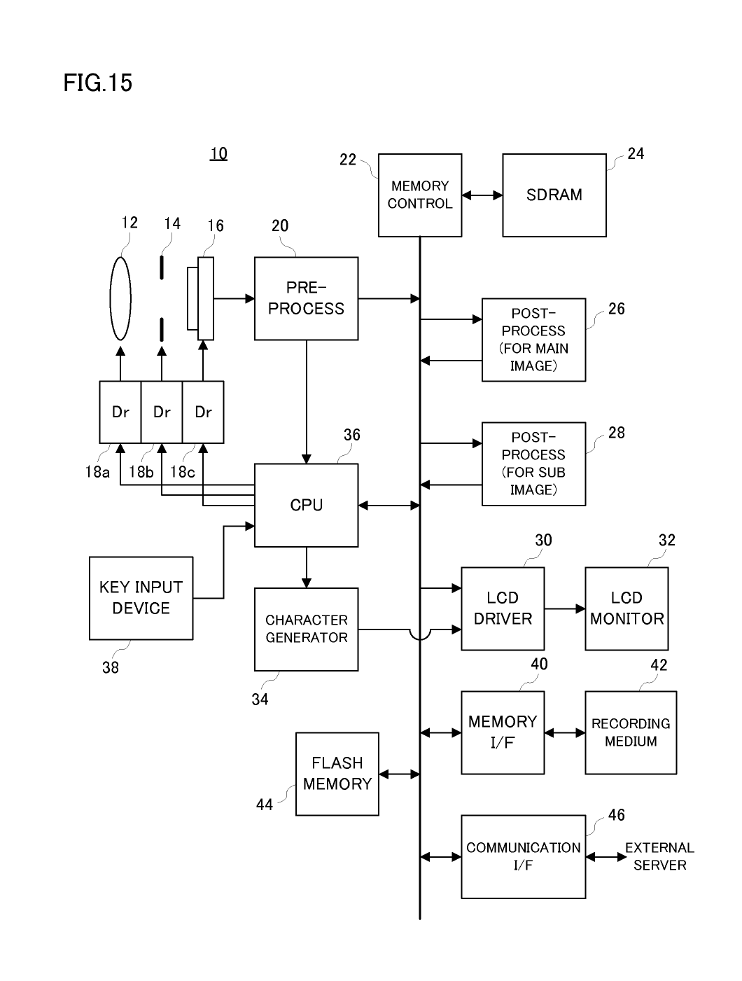

Moreover, in this embodiment, the control programs equivalent to the multi task operating system and a plurality of tasks executed thereby are previously stored in the flash memory 44. However, a communication I/F 46 may be arranged in the digital camera 10 as shown in FIG. 14 so as to initially prepare a part of the control programs in the flash memory 44 as an internal control program whereas acquire another part of the control programs from an external server as an external control program. In this case, the above-described procedures are realized in cooperation with the internal control program and the external control program.

Furthermore, in this embodiment, the processes executed by the CPU 36 are divided into a plurality of tasks in a manner described above. However, each of tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
a first creator which creates a first moving-image having a first frame rate based on output of an imager during a first period;
a second creator which creates a second moving-image having a second frame rate higher than the first frame rate based on the output of said imager during a second period belonging to the first period;
a reproducer which reproduces any one of the first moving-image created by said first creator and the second moving-image created by said second creator; and
a switcher which switches a reproducing target of said reproducer in response to a switching instruction issued during a period corresponding to the second period.

2. An image processing apparatus according to claim 1, further comprising an acceptor which accepts from a user a period-defining instruction of defining the second period.

3. An image processing apparatus according to claim 1, further comprising a notifier which generates a notification during the period corresponding to the second period in association with a reproducing process for the first moving-image by said reproducer, wherein the switching instruction is equivalent to an instruction accepted from the user.

4. An image processing apparatus according to claim 1, wherein said second creator includes a frame detector which detects a frame corresponding to commencement of the second period from among a plurality of frames forming the first moving-image, and said reproducer includes a reproduction-start-frame specifier which specifies a reproduction-start frame of the second moving-image with reference to a detection result of said frame detector.

5. An image processing apparatus according to claim 4, wherein said reproducer further includes a reproduction-frame identifier which repeatedly identifies a reproduction frame the first moving-image, and said reproduction-start-frame specifier specifies the reproduction-start frame with reference to an identification result of said reproduction-frame identifier.

6. An image processing apparatus according to claim 1, wherein a reproduction frame rate is common between the first moving-image and the second moving-image.

7. An image processing program recorded on a non-transitory recording medium in order to control an image processing apparatus, the program causing a processor of the image processing apparatus to perform the steps comprises:
a first creating step of creating a first moving-image having a first frame rate based on output of an imager during a first period;
a second creating step of creating a second moving-image having a second frame rate higher than the first frame rate based on the output of said imager during a second period belonging to the first period;
a reproducing step of reproducing any one of the first moving-image created by said first creating step and the second moving-image created by said second creating step; and
a switching step of switching a reproducing target of said reproducing step in response to a switching instruction issued during a period corresponding to the second period.
comprising:

8. An image processing method executed by an image processing apparatus, comprising:
a first creating step of creating a first moving-image having a first frame rate based on output of an imager during a first period;
a second creating step of creating a second moving-image having a second frame rate higher than the first frame rate based on the output of said imager during a second period belonging to the first period;
a reproducing step of reproducing any one of the first moving-image created by said first creating step and the second moving-image created by said second creating step; and
a switching step of switching a reproducing target of said reproducing step in response to a switching instruction issued during a period corresponding to the second period.
